(19) United States
(12) Patent Application Publication
(10) Pub. No.: US 2012/0104849 A1
(43) Pub. Date: May 3, 2012

(54) Electrical Supply Apparatus

(76) Inventor: Stewart John Robert Jackson, Bristol (GB)

(21) Appl. No.: 13/029,528

(22) Filed: Feb. 17, 2011

(30) Foreign Application Priority Data
Feb. 17, 2010 (GB) 10 02 654.0
Feb. 17, 2010 (GB) 10 02 655.7
Mar. 8, 2010 (GB) 10 05 848.5

(51) Int. Cl. H02J 3/00; H01R 43/00

(52) U.S. Cl. 307/31; 29/825

(57) ABSTRACT

Electrical supply apparatus (201) for providing electrical power to a first type of socket and a second type of socket (410). The apparatus comprises an electrical power source (420) for providing electrical power, a first mains circuit (204) for conveying electrical power to the first type of socket, a second mains circuit (208) for conveying electrical power to the second type of socket, and a control unit (210) configured to interrupt the supply of electrical power through the second mains circuit, and thus to the second type of socket. The interruption of electrical power through the second mains circuit does not interrupt the supply of electrical power to the first type of socket.

### CROSS REFERENCE TO RELATED APPLICATIONS

This application claims priority from United Kingdom Patent Application No. 10 02 654.0, filed 17 Feb. 2010, United Kingdom Patent Application No. 10 02 655.7, filed 17 Feb. 2010, and United Kingdom Patent Application No. 10 05 848.5, filed 8 Apr. 2010, which are hereby incorporated by reference in their entireties.

### BACKGROUND OF THE INVENTION

1. Field of the Invention

The present invention relates to controlling the supply of electrical power to electronic devices through a mains supply.

2. Description of the Related Art

Many electronic devices include a standby feature whereby the device enters an off state, but is still able to be turned back on through the use of a remote control, for example. Whilst the device may use substantially less power than it would when in operation, there is still a power draw associated with the standby state. Given many buildings contain a large number of such electronic devices, the power draw when all of the devices are in standby mode is quite significant. A problem is encountered when a user wishes to minimise the power draw of electronic devices when a standby mode is not required.

Such a period may occur overnight, when a house owner is asleep, or when office workers are not in their office premises. A user may unplug devices from their associated sockets, but this task may take a substantial length of time, especially in office environments.

### BRIEF SUMMARY OF THE INVENTION

According to a first aspect of the present invention, there is provided electrical supply apparatus for providing electrical power to a first type of socket and a second type of socket, comprising an electrical power source for providing electrical power, a first mains circuit for conveying electrical power to said first type of socket, a second mains circuit for conveying electrical power to said second type of socket, and a control unit configured to interrupt the supply of electrical power through said second mains circuit, and thus to said second type of socket, wherein the interruption of electrical power through said second mains circuit does not interrupt the supply of electrical power to said first type of socket.

According to a second aspect of the present invention, there is provided a method of installing an electrical supply to a building, comprising the steps of installing a first type of socket and a second type of socket, installing an electrical supply unit for providing electrical power, installing a first mains circuit for conveying electrical power to said first type of socket, installing a second mains circuit for conveying electrical power to said second type of socket, and installing a control unit configured to interrupt the supply of electrical power through said second mains circuit, and thus to said second type of socket, wherein the electrical supply is configured such that the interruption of electrical power to said second mains circuit does not affect the supply of electrical power to said first type of socket.

According to a third aspect of the present invention, there is provided apparatus for providing electrical power to electronic devices, comprising a first mains circuit for providing a constant power source for a first type of socket configured to provide an electronic device with electrical power; and a second mains circuit for providing an interruptible power source for a second type of socket configured to provide an electronic device with electrical power; wherein said second mains circuit includes a control unit comprising a first input for receiving electrical power, a first output for providing electrical power, a first switch connecting said first input and said second output, and a timer control for controlling said switch, wherein said first switch closes in response to a signal from said timer control, thus allowing electrical power to flow between said first input and said first output.

According to a fourth aspect of the present invention, there is provided electrical outlet apparatus for providing electrical power to electronic devices, comprising a first live terminal for receiving a constant supply of electrical power from said first mains circuit, a second live terminal for receiving an interruptible supply of electrical power from said second mains circuit, a neutral terminal for returning electrical power to said first mains circuit, a first socket for providing electrical power to a first electronic device, and a second socket for providing electrical power to a second electronic device, wherein said first socket is configured to receive electrical power from said first live terminal and return electrical power to said neutral terminal, and said second socket is configured to receive electrical power from said second live terminal and return electrical power to said neutral terminal.

### BRIEF DESCRIPTION OF THE SEVERAL VIEWS OF THE DRAWINGS

FIG. 1 shows an environment in which the invention may be embodied;

FIG. 2 shows a mains supply 201 in a ring configuration;

FIG. 3 shows a mains supply 301 in a radial configuration;

FIG. 4 shows an outlet 101;

FIG. 5 shows plug and socket types compatible with embodiments of the present invention;

FIG. 6 shows electrical connections in outlet 101;

FIG. 7 shows electrical wiring connected to outlet 101;

FIG. 8 shows a control unit for controlling the provision of power within an electrical circuit;

FIG. 9 shows a further electrical outlet 901; and

FIG. 10 shows alternative embodiments of outlet 901.

### DETAILED DESCRIPTION OF THE PREFERRED EMBODIMENTS

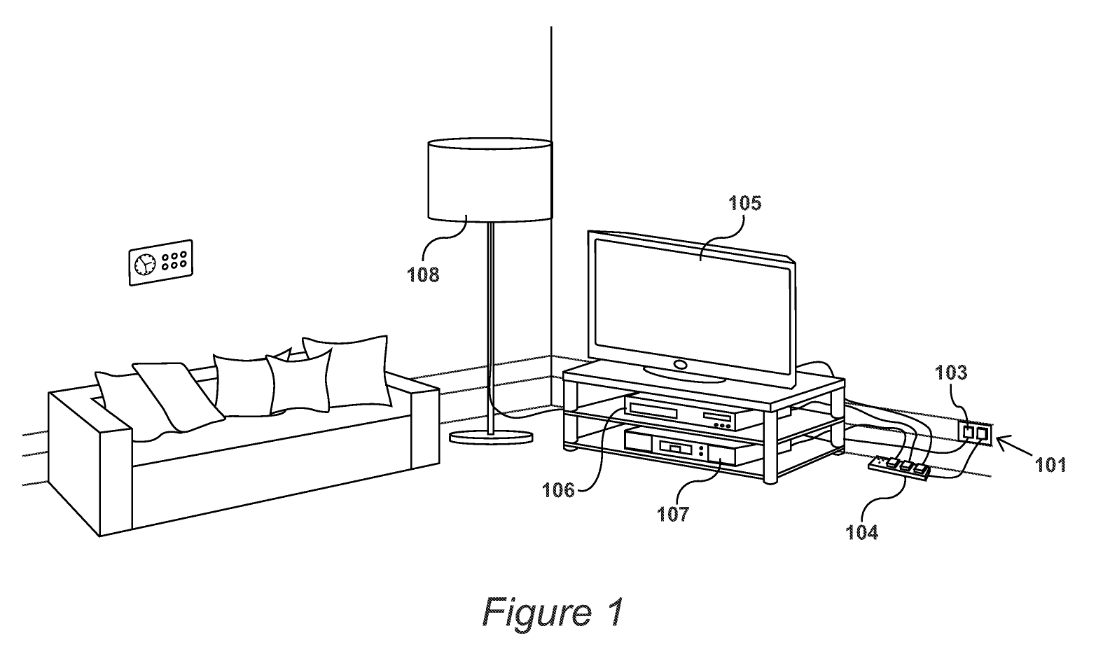

FIG. 1

An environment in which the present invention may be used is shown in FIG. 1. In this case, the environment is as living room in a household. The living room includes an outlet 101 comprising a first socket 102, and a second socket 103. Connected to first socket 102 is an extension cord 104, connected to which is a television 105, a DVD player 106 and a set top box 107. When in standby mode, devices such as television 105, DVD player 106 and set top box 107 consume around 5 to 10 Watts each. Thus if left in standby mode overnight, an electrical power draw of around 100 Watt-hours will be recorded by these devices alone.

Connected to second socket 103 is a lamp 108. Lamp 108 does not have a standby mode, and its switch completely interrupts its electrical supply. Additionally, the lamp may wish to be used by a house owner during the night in order to navigate through the living room. This is in contrast to devices such as television 105, DVD player 106 and set top box 107 which, for most users, will not be used during the night.

It is therefore an object of the present invention to provide a distinction between sockets for devices having a standby mode and sockets for devices that completely interrupt their electrical supply. Additionally, the present invention provides for an abstraction between types of sockets on the same outlet, along with a programmable timer for defining periods in which devices having a standby mode are not required, and thus may have their electrical supply interrupted.

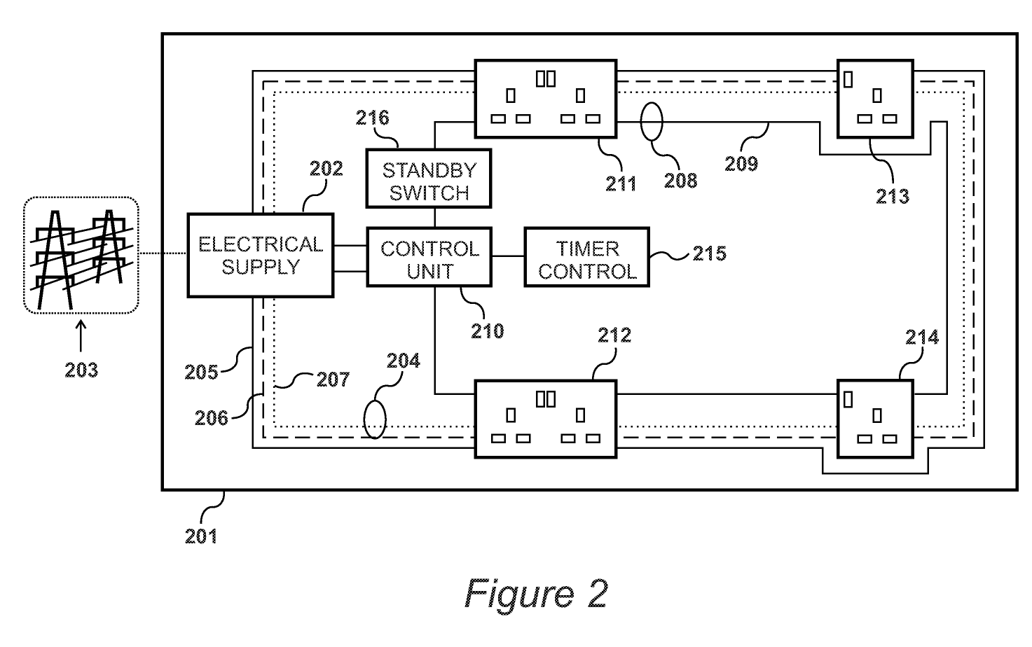

FIG. 2

FIG. 2 is a diagram illustrating a configuration of a mains supply 201 within a building. An electrical supply 202 receives power from an electrical grid 203 outside of a building, and includes means for tracking the use of electricity within a building. Such means is typically a consumer unit meter which records the amount of electrical power used in Watt-hours, which can then be read by the utility company. Alternatively, a smart meter may record the usage of electrical power and report the use in real-time to the utility company.

Mains supply 201 includes a first mains circuit 204 comprising a first live circuit 205, a neutral circuit 206 and an earthing circuit 207. Depending upon the installation, first live circuit 205, neutral circuit 206 and earthing circuit 207 can be cabled separately, or can be grouped together in a combined cable.

Mains supply 201 also includes a second mains circuit 208, which comprises a second live circuit 209. This provides a second, interruptible live supply to certain outlets. The second live circuit 209 is interruptible by control unit 210. In this embodiment, control unit 210 includes a switch for controlling the provision of electrical power through second live circuit 209. Control unit 210 is instructed to interrupt the supply of power through second live circuit 209 by a timer control 215. This allows the provision of power to devices connected to second live circuit 209 to be controlled in dependence upon the current time. Additionally, second live circuit 209 includes a standby switch 216 that allows the manual interruption of the power supply to outlets within second live circuit 209.

Mains supply 201 also comprises outlets 211, 212, 213 and 214. Outlet 211 is a double-gang outlet configured to receive two plugs. Outlet 212 is identical to outlet 211. Outlets 213 and 214 are both single-gang outlets, and are configured to receive a single plug.

The first live circuit 204 provides a constant supply of electrical power to outlets 211, 212 and 213. The second live circuit 209 provides an interruptible supply of electrical power to outlets 211, 212 and 214.

Neutral circuit 205 returns electrical power from outlets 211 to 214 to the electrical supply 202. The earthing circuit 206 provides means of earthing the outlets 211 to 214. It is to be appreciated that in other embodiments an earthing circuit may not be present depending upon electrical standards in the country of installation.

Thus, in the example shown, one side of each of the outlets 211 and 212 are provided with a constant supply of electrical power, and are therefore suitable for powering devices such as lamp 108. The other side is provided with an interruptible supply of electrical power, and is therefore suitable for devices having a standby mode such as television 105.

Outlet 213 provides a constant supply of electrical power to connected devices (such as a 24 hour alarm clock), as it is connected within the first live circuit 204. Outlet 214 provides an interruptible supply of electrical power to connected devices, as it is connected within the second live circuit 209.

In an alternative embodiment, all of outlets 211 to 214 are connected within second mains circuit 209. Thus, all outlets will provide an interruptible supply of electrical power to connected devices.

In FIG. 2, the first mains circuit and the second mains circuit are wired in a ring configuration. This configuration allows the use of wire with half the current carrying capacity of that used in an equivalent radial circuit.

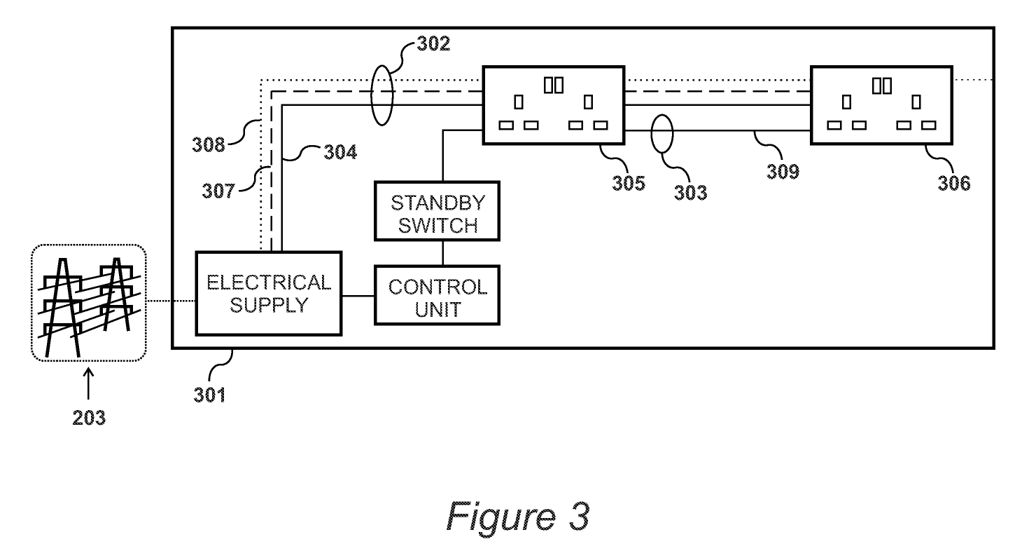

FIG. 3

FIG. 3 illustrates an alternative installation of a mains supply 301 comprising a first mains circuit 302 and a second mains circuit 303. The electrical supply and the control unit are identical to those previously described with reference to FIG. 2. However, the first mains circuit 302 and the second mains circuit 303 are instead installed in a radial configuration.

In this configuration, one supply of electricity is provided by a first live circuit 304, which flows through outlet 305 and terminates at the final outlet in the circuit 306 in the circuit. The electrical power returns through neutral circuit 307. If suitable, earthing circuit 308 provides a path to earth from the sockets.

The second mains circuit 303, comprising a second live circuit 309, provides an interruptible supply of electrical power to outlets 305 and 306. As with the first mains circuit, it terminates at the final outlet in the circuit, which in this example is outlet 306.

Whilst the radial circuit may require wiring with double the current-carrying capacity of an equivalent ring circuit, it does provide a higher level of fault tolerance to power surges and failure of connected electronic devices.

The present invention is suitable for installation within both ring and radial circuits, and thus in a new building, a person is free to choose which type of wiring scheme is used.

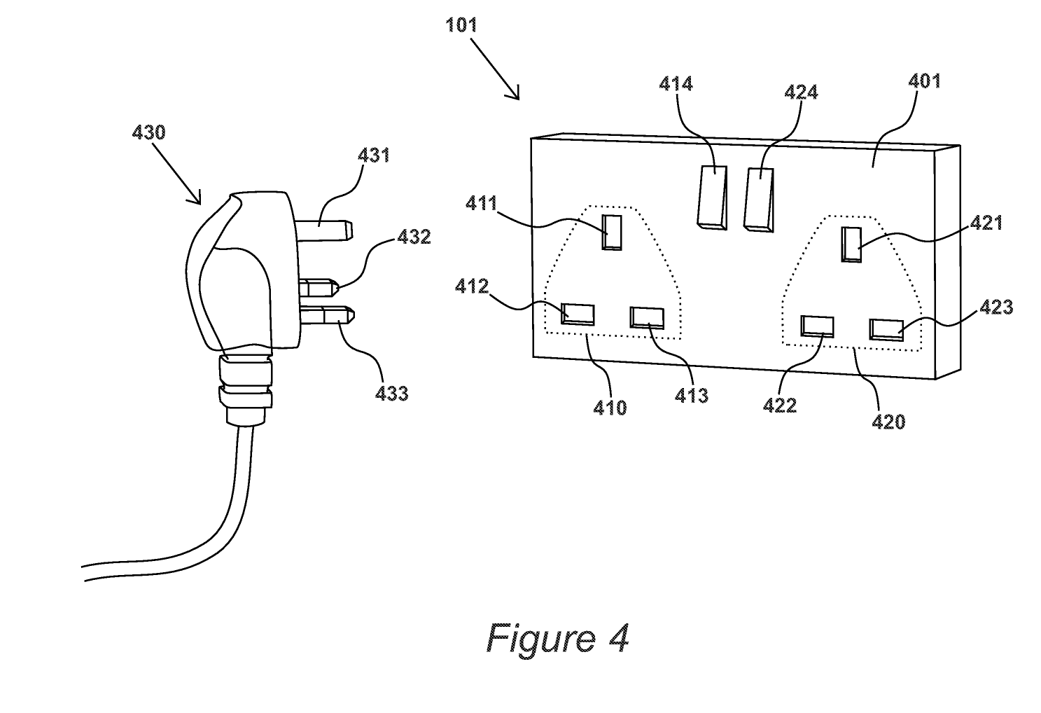

FIG. 4

FIG. 4 shows outlet 101 in greater detail, along with a complementary plug 430 attached to an electronic device.

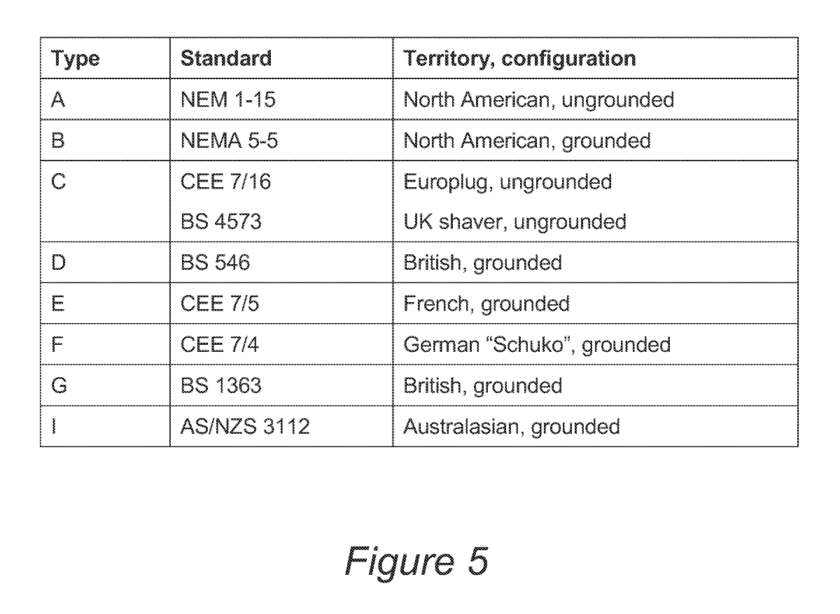

Outlet 101 includes a faceplate 401, a first socket 410 and a second socket 420. In the embodiment shown in FIG. 4, the first socket 410 and the second socket 420 are configured to receive plugs of type G (BS1363 British grounded), such as plug 430. In this configuration, the earthing circuit 207 is present within mains supply 201, and thus provides a route to earth for electrical power. In further embodiments, outlet 101 is configured to receive plugs of different standards. The plug types, standards and territories in which they are found will be further described with reference to FIG. 5.

The first socket 410 includes three apertures 411, 412 and 413. Plug 430 includes three pins 431, 432 and 433, which are configured to be inserted into apertures 411, 412 and 413 respectively.

Aperture 411 and pin 431 are for connecting the electronic device to ground via a grounding circuit 207. Aperture 412 and pin 432 are for connecting a device to a live circuit. Aperture 413 and pin 433 are for connecting a device to a neutral circuit.

The second socket 420 is identical in configuration to socket 410, and includes apertures 421, 422 and 423 which are also configured to receive the pins 431, 432 and 433 on the plug 430.

A switch 414 controls the provision of power to the first socket 410, and a switch 424 controls the provision of power to the second socket 420.

FIG. 5

A table of plug types that can be accepted in various embodiments of the outlet 101 is shown in FIG. 5.

The plug type is shown in the first column, and the associated standard shown in the second column. The plug's associated territory of use and details as to whether or not the plug requires grounding are shown in the third column.

Plugs of type A and C do not require grounding, and as such would be used in an installation where an earthing circuit is not present within the first mains circuit.

Plugs of type B, D, E, F, G or I must be grounded, and would therefore be used in an installation where an earthing circuit is present within the first mains circuit.

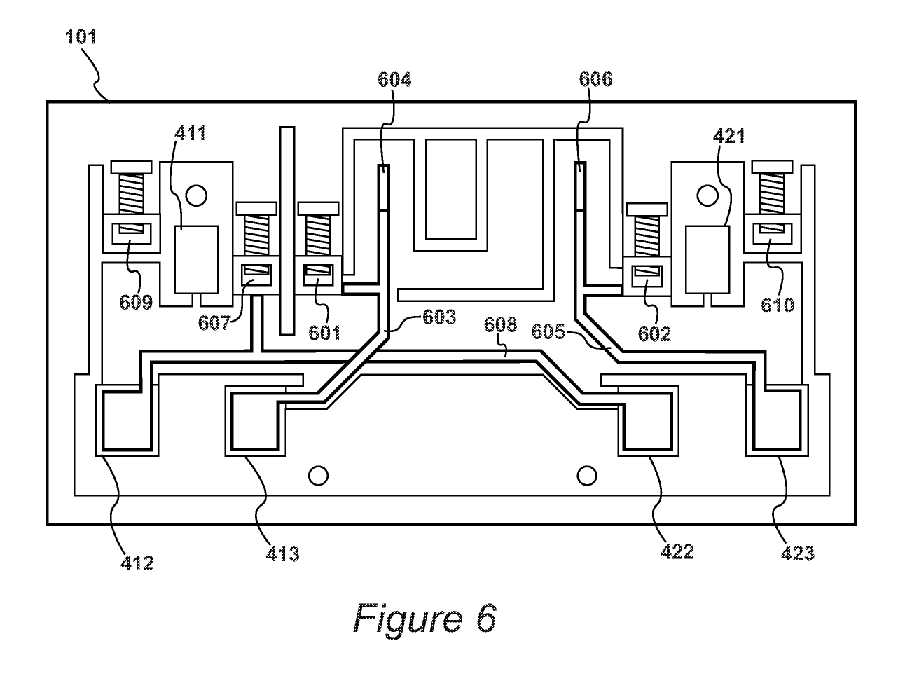

FIG. 6

A diagram showing connections behind the faceplate 401 of outlet 101 is shown in FIG. 6.

Outlet 101 includes a first live terminal 601 for receiving a constant supply of electrical power from first mains circuit 205, and a second live terminal 602 for receiving an interruptible supply of electrical power from the second mains circuit 207.

A first live bar 603 connects first live terminal 601 to aperture 413 in first socket 410 on the left, and includes a portion 604 that is connected or broken by the switching of switch 414. This allows the provision of electrical power via first live bar 603 to be interrupted by switch 414.

A second live bar 605 connects the second live terminal 602 to aperture 423 in second socket 420 on the right, and also includes a portion 606 that allows the interruption of electrical power from the second mains circuit by the switching of switch 424.

Outlet 101 also includes a neutral terminal 607 for the returning electrical power to first mains circuit, and is connected to both aperture 412 in first socket 410 and to aperture 422 in second socket 420 by a neutral bar 608.

Thus, electrical power is provided by both a constant supply from the first mains circuit and an interruptible supply from the second mains circuit. The electrical power is then returned from both of these circuits via the neutral circuit within the first mains circuit.

As shown in FIG. 6, outlet 101 also includes two earthing terminals 609 and 610 for connecting aperture 411 in socket 410 and aperture 421 in socket 420 to earth. This is achieved by connecting terminal 609 and terminal 610 to the earthing circuit within the first mains circuit. If an earthing circuit is not present, then these terminals will not be connected to any circuit.

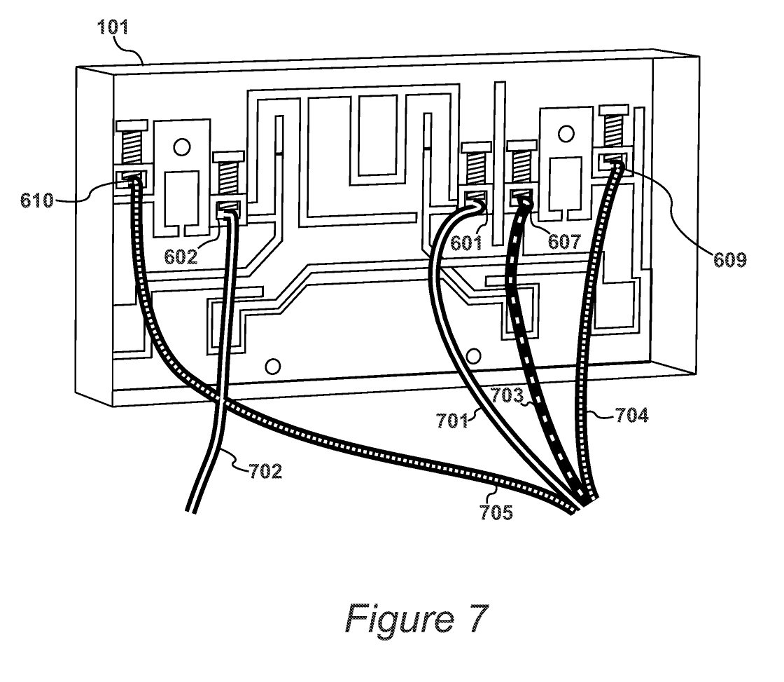

FIG. 7

FIG. 7 shows the connections of mains cabling to the terminals in the rear of outlet 101. For the purposes of illustration, only a single cable is shown as connecting to each terminal. However, in practice, a duplicate cable would connect to each terminal in order to complete the mains circuit.

When installed in the ring circuit installation of FIG. 2, and thus being equivalent to outlets 211 and 212, wiring 701 from the first live circuit 205 will be connected to the first live terminal 601. Similarly, wiring 702 from the second live circuit 209 will be connected to the second live terminal 602. Additionally, wiring 703 from the neutral circuit 206 will be connected to the neutral terminal 607, whilst wiring 704 and 705 from the earthing circuit 207 will be connected to the earthing terminals 609 and 610.

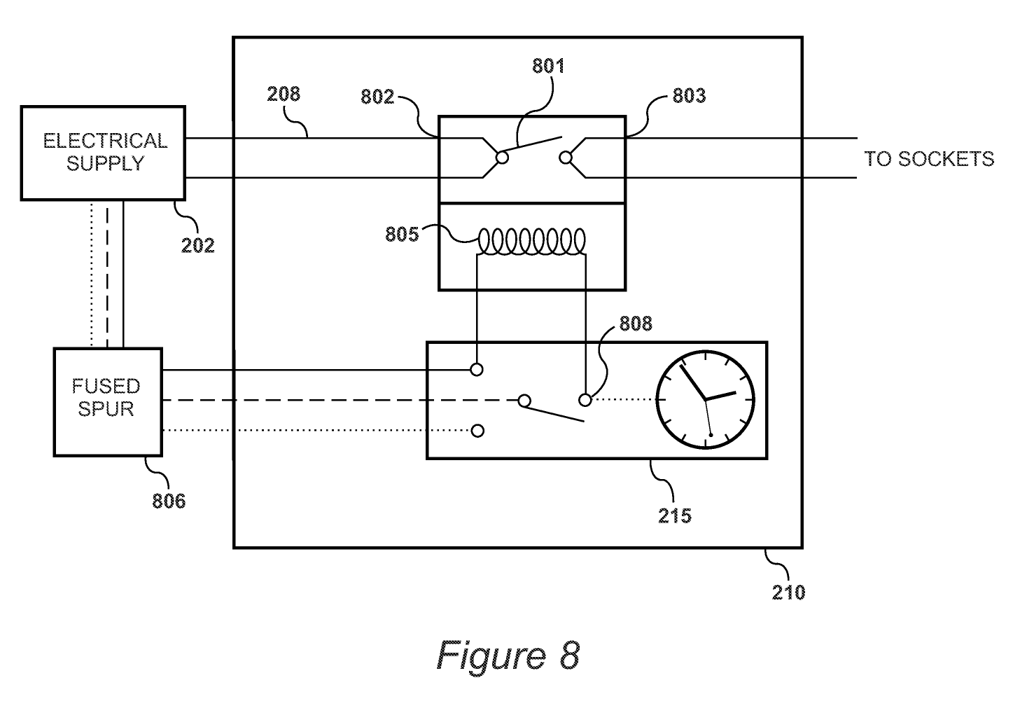

FIG. 8

FIG. 8 shows control unit 210 for controlling the provision of power within a mains circuit such as second mains circuit 208. In this example, second mains circuit 208 is installed in a ring configuration, and thus two wiring cores are shown. In the case where second mains circuit is installed in a radial configuration, only one wiring core would be present.

Electrical supply 202 supplies second live circuit 208 with electrical power, which is interruptible by a switch 801. Switch 801 connects a first input 802 and a first output 803. Switch 801 closes in response to a signal from timer control 215. This allows electrical power to flow between first input 802 and first output 803.

Switch 801 is controlled by a magnetic coil 805, which produces a magnetic field when a current flows through it. Upon the application of a magnetic field, switch 801 closes and electrical power flows through second mains circuit 208. Magnetic coil 805 is controlled by timer control 215, which is powered by a fused spur 806 from electrical supply 202. In a further example, timer control 215 is powered directly from electrical supply 202. Additionally, timer control 215 can be either integrated with or remote from control unit 210.

A timer 807 instructs a timer switch 808 to close and thus completes the circuit from the fused spur 806, which in turn causes magnetic coil 805 to activate, producing the magnetic field that closes switch 801.

Thus, the provision of timer 807 allows switch 801 to close between prescribed times of day. This has the effect of allowing power to flow through second mains circuit 208, and therefore to sockets such as socket 420.

Any device which is plugged in to a socket such as socket 420 will therefore be able to draw power from electrical supply 202. When switch 801 is open, no power will flow through second mains circuit 208, and thus the electrical devices plugged in to sockets such as socket 420 will not be able to draw power even if they are in a standby mode. Therefore, the power drawn by devices such as television 105, DVD player 106 and set top box 107 is nullified, resulting in substantial savings in usage of electricity from electrical supply 202.

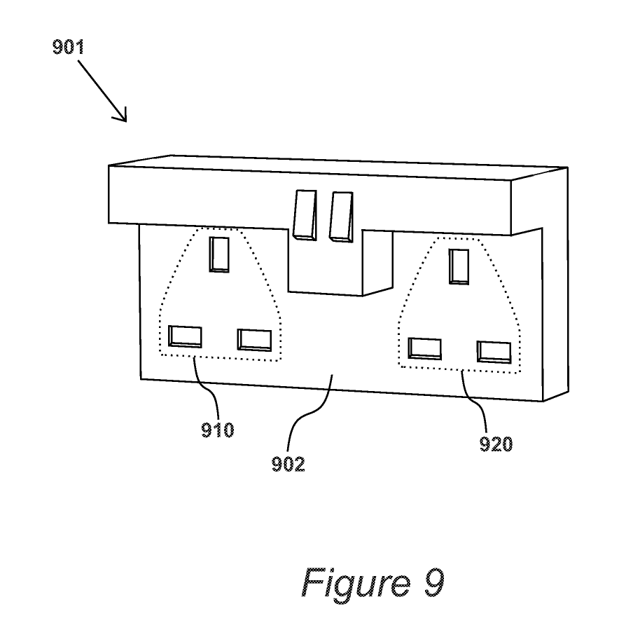

FIG. 9

FIG. 9 illustrates a further example of an electrical outlet that may be used in conjunction with an electrical installation having a first mains circuit and a second mains circuit.

Outlet 901 includes a first socket 910 and a second socket 920, which are substantially similar to first socket 410 and second socket 420 respectively illustrated previously with reference to FIG. 4. Thus, first socket 910 draws power from first mains circuit 204, whilst second socket 920 draws power from second mains circuit 209. Alternatively, first socket 910 and second socket 920 could be configured such that they draw power from only one of first mains circuit 204 or from second mains circuit 209. In this embodiment, outlet 901 includes a radio frequency controller 902.

Radio-frequency controller 902 includes a radio-frequency receiver (not shown), a switch (not-shown) and a fuse (not shown), along with various additional electrical components known to those skilled in the art. Upon receiving a signal, the radio-frequency receiver instructs the switch to interrupt the supply of power from second mains circuit 209 to socket 920. This facilitates the control of individual sockets in installations with a large number of outlets.

In alternative embodiments, outlet 901 may comprises an analogue/digital pulse receiver providing substantially the same functionality as radio frequency controller 902.

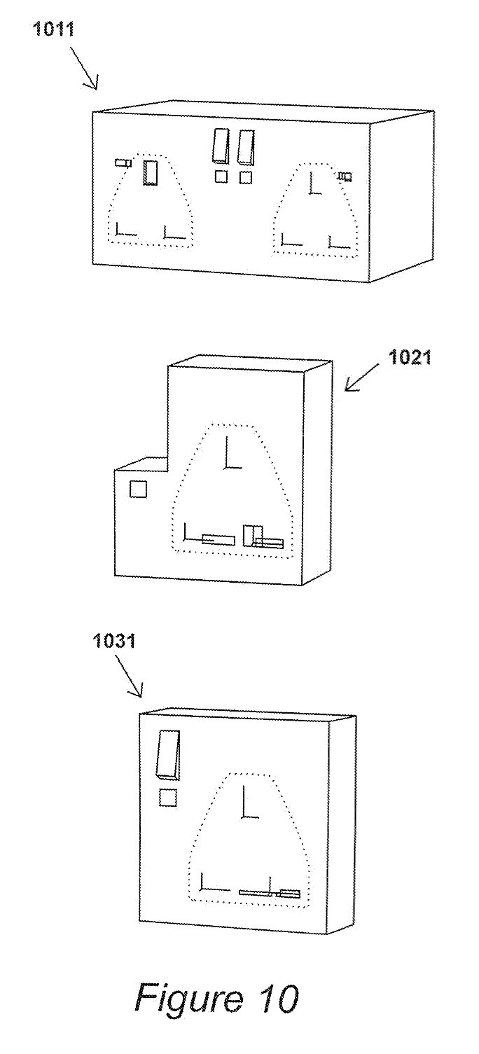

FIG. 10

Alternative embodiments of outlet 901 are illustrated in FIG. 10.

Outlet 1011 is a double gang outlet, and is substantially cuboid in shape, and accommodates radio frequency controller 902 and associated electronics in the cuboid housing.

Outlet 1021 is a single gang outlet, with radio frequency controller 902 and associated electronics housed within it. Outlet 1021 is configured to be movable within a building.

Outlet 1031 is a single gang outlet, accommodating radio frequency controller 902 and associated electronics within it. Outlet 1041 is configured to be fixed in place within a building.

1. Electrical supply apparatus for providing electrical power to a first type of socket and a second type of socket, comprising:
an electrical power source for providing electrical power, a first mains circuit for conveying electrical power to said first type of socket,
a second mains circuit for conveying electrical power to said second type of socket, and
a control unit configured to interrupt the supply of electrical power through said second mains circuit, and thus to said second type of socket; wherein:
the interruption of electrical power through said second mains circuit does not interrupt the supply of electrical power to said first type of socket.

2. Electrical supply apparatus in accordance with claim 1, wherein said first mains circuit comprises:
a first live circuit for providing electrical power from said electrical supply unit to said first type of socket, and
a neutral circuit for returning electrical power from said first type of socket and said second type of socket to said electrical supply unit; and
said second mains circuit comprises a second live circuit for providing electrical power from said electrical supply unit to said second type of socket.

3. Electrical supply apparatus in accordance with claim 2, wherein said first mains circuit further comprises an earthing circuit for connecting said first type of socket and said second type of socket to earth.

4. Electrical supply apparatus in accordance with claim 1, wherein each of said first mains circuit and said second mains circuit is a ring circuit.

5. Electrical supply apparatus in accordance with claim 1, wherein each of said first mains circuit and said second mains circuit is a radial circuit.

6. Electrical supply apparatus in accordance with claim 1, wherein each of said first type of socket and said second type of socket are configured to receive plugs of types A, B, C, D, E, F, G or I.

7. Electrical supply apparatus in accordance with claim 1, wherein each of said first type of socket and said second type of socket are located on separate outlet face plates.

8. Electrical supply apparatus in accordance with claim 1, wherein said first type of socket and said second type of socket are located on the same outlet face plate.

9. Electrical supply apparatus in accordance with claim 1, wherein said control unit comprises a switch for controlling the flow of electrical power to said second mains circuit.

10. Electrical supply apparatus in accordance with claim 9, wherein said switch is controlled by a timer.

11. Electrical supply apparatus in accordance with claim 10, wherein said timer is configured by a user to open said switch during times of day when power is not required in said second mains circuit.

12. A method of installing an electrical supply to a building, comprising the steps of:
installing a first type of socket and a second type of socket,
installing an electrical supply unit for providing electrical power,
installing a first mains circuit for conveying electrical power to said first type of socket,
installing a second mains circuit for conveying electrical power to said second type of socket, and
installing a control unit configured to interrupt the supply of electrical power through said second mains circuit, and thus to said second type of socket; wherein:
the electrical supply is configured such that the interruption of electrical power to said second mains circuit does not affect the supply of electrical power to said first type of socket.

13. A method in accordance with claim 12, wherein said step of installing a first mains circuit comprises the steps of:
installing a first live circuit for providing electrical power from said electrical supply unit to said first type of socket,
installing a neutral circuit for returning electrical power from said first type of socket and said second type of socket to said electrical supply unit,
installing an earthing circuit for connecting said first type of socket and said second type of socket to earth.

14. A method in accordance with claim 12, wherein said step of installing said second mains circuit comprises the step of installing a second live circuit for providing electrical power from said electrical supply unit to said second type of socket.

15. A building comprising electrical supply apparatus in accordance with claims 1.
